(19) United States
(12) Patent Application Publication
(10) Pub. No.: US 2013/0155275 A1
(43) Pub. Date: Jun. 20, 2013

(54) IMAGE CAPTURING APPARATUS, IMAGE CAPTURING METHOD, AND COMPUTER-READABLE RECORDING MEDIUM STORING IMAGE CAPTURING PROGRAM

(71) Applicant: FUJITSU LIMITED, Kawaski-shi (JP)

(72) Inventors: Masayoshi Shimizu, Hadano (JP); Satoshi Nakashima, Kawasaki (JP); Nobuyuki Kanto, Kobe (JP)

(73) Assignee: FUJITSU LIMITED, Kawasaki-shi (JP)

(21) Appl. No.: 13/677,643

(22) Filed: Nov. 15, 2012

(30) Foreign Application Priority Data
Dec. 15, 2011 (JP) 2011-274778

(51) Int. Cl. H04N 5/225; H04N 9/73

(52) U.S. Cl. CPC H04N 5/2256; H04N 9/735
USPC 348/223.1; 348/370

(57) ABSTRACT

An image capturing apparatus includes: an image capturing device in which a plurality of pixels having sensitivity to visible light and illuminating light in a certain wavelength range are arranged and that captures a moving image having a plurality of frames; a radiation device that radiates the illuminating light onto an image capturing region of the image capturing device; and a processor that executes a procedure, the procedure comprising: selecting, from among a plurality of frames captured by the image capturing device, a frame captured during an OFF period of the radiation device, and outputting the selected frame as a frame representing a visible image of the image capturing region.

### CROSS-REFERENCE TO RELATED APPLICATION

This application is based upon and claims the benefit of priority of the prior Japanese Patent Application No. 2011-274778, filed on Dec. 15, 2011, the entire contents of which are incorporated herein by reference.

### FIELD

The embodiments discussed herein are related to an image capturing apparatus, an image capturing method, and a computer-readable recording medium storing an image capturing program.

### BACKGROUND

As a measurement technique using a camera, a technique is widely known in which a light source radiates light onto an object and reflected light is received by the camera to measure the object. This measurement technique is sometimes called “active sensing”. The active sensing is adopted in various measurement techniques such as, for example, distance measurement and line-of-sight measurement. In the active sensing, for example, a near-infrared light source that radiates infrared light is used as a light source and a camera having sensitivity to infrared light is used in many cases. As the near-infrared light source, a near-infrared light-emitting diode (LED) is used.

An apparatus that obtains an infrared image is disclosed, for example, in Japanese Laid-open Patent Publication No. 2008-8700. The apparatus radiates infrared pulse light in every other one frame scanning period and generates a visible light image in every one frame scanning period. The apparatus then subtracts an infrared pixel signal at a time when the pulse light is not radiated from an infrared pixel signal at a time when the pulse light is radiated.

On the other hand, a camera that captures only a normal color image (visible image) is configured to receive only visible light in order to reproduce colors close to those perceived by humans. This is because, if the camera has sensitivity not only to a visible range but also to an infrared range, an image having colors different from those perceived by humans is undesirably captured due to the effect of infrared light. In such a camera, a filter that blocks infrared light is normally provided.

In addition, there is a demand for performing the active sensing using infrared light and capture of a normal moving image composed of visible images at the same time using a single camera having sensitivity to both the visible range and the infrared range as a camera for both the active sensing and the capture of the moving image composed of the visible images.

For example, in Japanese Laid-open Patent Publication No. 2005-331413, a camera is disclosed that is provided with an image sensor including pixels that receive red (R), green (G), and blue (B) light, respectively, and pixels that receive infrared light Ir. In this case, a filter that let R, G, B, or Ir light pass therethrough is attached to each pixel, but the resolution of a visible image decreases due to the pixels for infrared light. In addition, for example, in Japanese Laid-open Patent Publication No. 7-246185, a technique is disclosed in which a color disk having a filter for visible light and a filter for infrared light is rotated to capture both a visible image and an infrared image. However, since the color disk is rotated, manufacturing cost is high.

Therefore, it is desirable that, without providing a filter that blocks infrared light, the active sensing and the capture of a moving image composed of visible images can be performed at the same time using a single camera whose pixels have sensitivity to both the visible range and the infrared range. However, as described above, a camera having sensitivity to the infrared range undesirably captures a visible image affected by infrared light.

For example, in Japanese Patent No. 4397724, a technique for correcting deterioration of color due to radiation of infrared light using matrix correction is disclosed.

### SUMMARY

According to an aspect of the invention, an image capturing apparatus includes: an image capturing device in which a plurality of pixels having sensitivity to visible light and illuminating light in a certain wavelength range are arranged and that captures a moving image having a plurality of frames; a radiation device that radiates the illuminating light onto an image capturing region of the image capturing device; and a processor that executes a procedure, the procedure comprising: selecting, from among a plurality of frames captured by the image capturing device, a frame captured during an OFF period of the radiation device, and outputting the selected frame as a frame representing a visible image of the image capturing region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the overall configuration of an image capturing apparatus according to a first embodiment;

FIG. 2 is a schematic block diagram illustrating an example of a hardware configuration in an aspect in which an image capturing apparatus is realized by a program;

FIG. 3 is a flowchart illustrating an image capturing process according to the first embodiment;

FIG. 4 is an example of a timing chart illustrating the image capturing process according to the first embodiment;

FIG. 5 is a flowchart illustrating an example of a modification of the image capturing process according to the first embodiment;

FIG. 6 is a block diagram illustrating an example of a modification of the overall configuration of the image capturing apparatus according to the first embodiment;

FIG. 7 is a block diagram illustrating the overall configuration of an image capturing apparatus according to a second embodiment;

FIG. 8 is a flowchart illustrating a judgment/image capturing process according to the second embodiment;

FIGS. 9A and 9B are diagrams illustrating specific examples of histograms of x values and y values;

FIG. 10 is a flowchart illustrating a continuous radiation image capturing process according to the second embodiment;

FIG. 11 is a flowchart illustrating an example of a modification of the judgment/image capturing process according to the second embodiment;

FIG. 12A is a diagram illustrating an example of a state in which a frame captured while a radiation unit is on has been divided into a plurality of regions, and FIG. 12B is a diagram illustrating an example of a state in which a frame captured while the radiation unit is off has been divided into a plurality of regions;

FIG. 13 is a flowchart illustrating an example of a modification of the judgment/image capturing process according to the second embodiment;

FIG. 14 is a block diagram illustrating an example of a modification of the overall configuration of the image capturing apparatus according to the second embodiment;

FIG. 15 is a block diagram illustrating the overall configuration of an image capturing apparatus according to a third embodiment;

FIG. 16 is a flowchart illustrating an image capturing process according to the third embodiment;

FIG. 17 is an example of a timing chart illustrating the image capturing process according to the third embodiment; and

FIG. 18 is a block diagram illustrating an example of a modification of the overall configuration of the image capturing apparatus according to the third embodiment.

### DESCRIPTION OF EMBODIMENTS

Because the degree of deterioration of color depends on the intensity of infrared light, a correction process is performed using correction intensity according to the intensity of the infrared light. However, the intensity of the infrared light might be different between portions of an image capturing region. For example, this holds true for a case in which the entirety of a room is illuminated by a lamp inside the room and a light source of infrared light radiates the infrared light onto only objects close to the light source. In this case, since the objects close to the light source receive intense infrared light and the infrared light does not reach regions far from the light source, the degree of deterioration of color due to the infrared light is different between portions. In such a situation in which the intensity of infrared light is different between the portions, it is difficult for the above-described related art to properly correct the entirely of an image.

In addition, there is a case in which a dot pattern of infrared light is radiated for active sensing. In this case, correction is more difficult. There can also be a case in which not infrared light but visible light in a particular wavelength range is radiated in the active sensing. In this case, the same problem arises.

In a technique disclosed herein, a visible image in which the deterioration of color due to the effect of illuminating light in a certain wavelength range is suppressed is obtained using a single image capturing unit having sensitivity to visible light and the illuminating light.

An example of embodiments of the technique disclosed herein will be described in detail hereinafter with reference to the drawings.

### First Embodiment

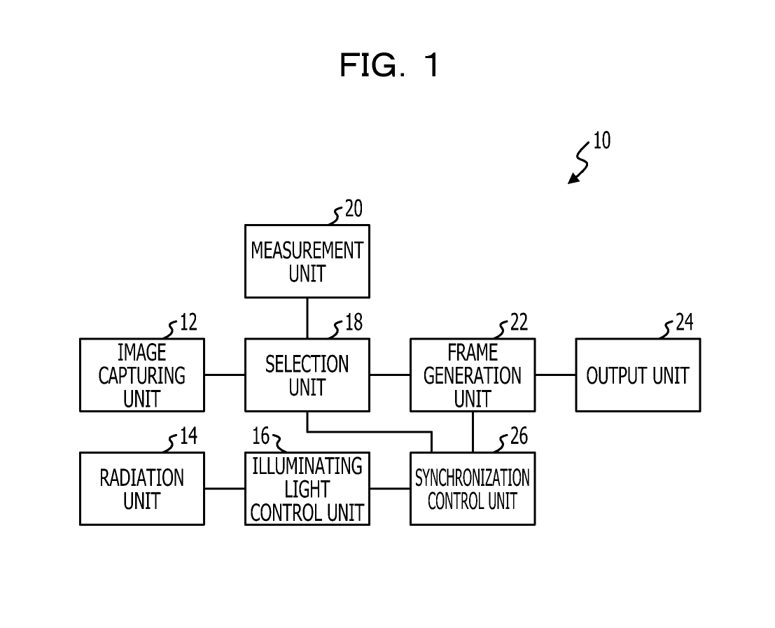

FIG. 1 illustrates an image capturing apparatus 10 according to an embodiment. The image capturing apparatus 10 includes an image capturing unit 12, a radiation unit 14, an illuminating light control unit 16, a selection unit 18, a measurement unit 20, a frame generation unit 22, an output unit 24, and a synchronization control unit 26. The function components of the image capturing apparatus 10 except for the image capturing unit 12 and the radiation unit 14 can be realized, for example, by an electronic circuit or the like. Alternatively, the image capturing apparatus 10 except for the image capturing unit 12 and the radiation unit 14 may be realized, for example, by a semiconductor integrated circuit or, more specifically, an application-specific integrated circuit (ASIC) or the like. Alternatively, the image capturing apparatus 10 may further include an operation unit, which is an input device that receives an operation input by a user.

In the image capturing unit 12, a plurality of pixels having sensitivity to visible light and illuminating light in a certain wavelength range are arranged, and the image capturing unit 12 captures an image capturing region. In this embodiment, the illuminating light in the certain wavelength range is light mainly composed of infrared light. The light mainly composed of infrared light will be simply referred to as the infrared light hereinafter. The image capturing unit 12 may be, for example, an image capturing unit that includes an image capturing device such as a charge-coupled device (CCD) or a complementary metal-oxide-semiconductor (CMOS) image sensor. Each of the plurality of pixels arranged in the image capturing unit 12 is provided with any of R, G, and B color filters, and a color visible image can be captured. The arrangement of the RGB color filters is a known arrangement such as a Bayer pattern. In this embodiment, a filter that blocks infrared light is not provided for the image capturing unit 12. Therefore, each pixel in the image capturing unit 12 has sensitivity to an infrared range.

In addition, the image capturing unit 12 is configured in such a way as to be able to capture not only a still image but also a moving image that includes a plurality of frames. In the following description, capture of a moving image is focused upon. In this embodiment, the image capturing unit 12 captures a moving image at a certain frame rate. The image capturing unit 12 outputs image data regarding each captured image obtained by capturing the moving image to the selection unit 18. Alternatively, the image capturing apparatus 10 according to this embodiment may be an electronic device provided with the image capturing unit 12. The electronic device is, for example, a digital camera or a mobile terminal.

The radiation unit 14 radiates infrared light onto the image capturing region of the image capturing unit 12. The radiation unit 14 may be, for example, an LED that radiates infrared light. The illuminating light radiated by the radiation unit 14 is not limited to infrared light. For example, the illuminating light radiated by the radiation unit 14 may be near-infrared light or light in a particular wavelength range included in a visible range. Turning on and off of the radiation unit 14 is controlled by the illuminating light control unit 16.

The selection unit 18 selects, from among pieces of image data regarding a plurality of frames output from the image capturing unit 12, image data regarding frames captured during an OFF period of the radiation unit 14, which is a period in which the radiation unit 14 is off, as image data regarding frames representing visible images. The selection unit 18 inputs the selected image data regarding the frames to the frame generation unit 22. In addition, the selection unit 18 inputs image data regarding frames that has not been selected to the measurement unit 20. The image data regarding frames that has not been selected is image data regarding frames captured during an ON period of the radiation unit 14, which is a period in which the radiation unit 14 is on.

The measurement unit 20 executes a certain measurement process using the image data regarding the frames input from the selection unit 18. In this embodiment, the measurement unit 20 executes a line-of-sight measurement process in which the user's line of sight existing in the image capturing region of the image capturing unit 12 is measured. For example, a method disclosed in the following document may be adopted in line-of-sight measurement: Takashi Nagamatsu, et al. “Three-Dimensional Line-of-Sight Measurement Method Using Corneal Reflection: Estimation of Line of Sight Using Rotational Models of Optical Axis and Visual Axis of Eyeball Based on Listing's Law”, December 2010 Issue of Image Laboratory, pp. 57-63.

The frame generation unit 22 inputs the image data regarding the frames input from the selection unit 18 to the output unit 24. In addition, the frame generation unit 22 generates image data regarding the frames corresponding to the ON period of the radiation unit 14 and inputs the image data to the output unit 24. In the frame generation unit 22, a frame buffer that can hold image data regarding at least one frame is provided. The frame generation unit 22 stores image data regarding one frame in the frame buffer each time the image data is input from the selection unit 18. In this embodiment, the frame generation unit 22 generates the image data by copying the image data stored in the frame buffer.

The output unit 24 outputs the image data regarding the frames input from the frame generation unit 22 to the outside as image data regarding frames representing visible images of the image capturing region. An output target may be a display 32, which will be described later, an external storage apparatus, or an external apparatus connected to a communication network.

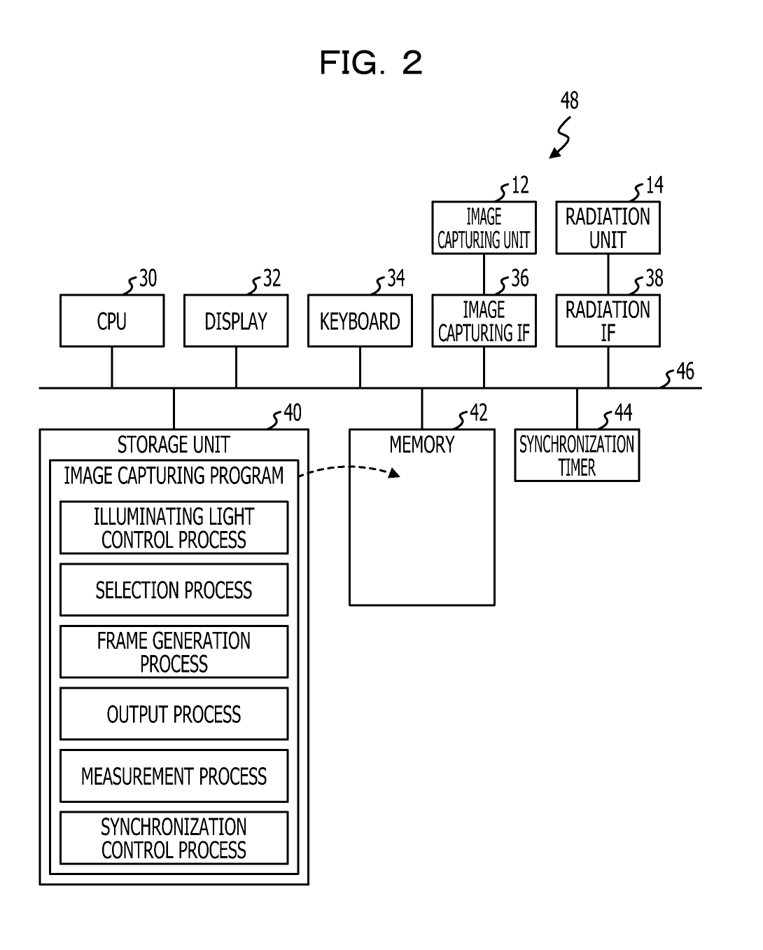

The synchronization control unit 26 synchronizes the illuminating light control unit 16, the selection unit 18, and the frame generation unit 22 with one another using a count value of a synchronization timer 44 (also refer to FIG. 2) that counts up in accordance with clock signals generated at certain intervals.

The functions of the image capturing apparatus 10 except for those of the image capturing unit 12 and the radiation unit 14 can be realized, for example, by a computer 48 illustrated in FIG. 2, instead. The computer 48 includes a central processing unit (CPU) 30, the display 32, a keyboard 34 as an example of an operation unit, an image capturing unit interface (IF) 36, a radiation unit IF 38, a nonvolatile storage unit 40, a memory 42, and the synchronization timer 44, which are connected to one another through a bus 46. The image capturing unit 12 is connected to the image capturing unit IF 36, and the radiation unit 14 is connected to the radiation unit IF 38.

The storage unit 40 stores an image capturing program for causing the computer 48 to which the image capturing unit 12 and the radiation unit 14 are connected to function as the image capturing apparatus. The CPU 30 reads the image capturing program from the storage unit 40 and expands the image capturing program on the memory 42 to execute one of processes included in the image capturing program.

The image capturing program includes an illuminating light control process, a selection process, a frame generation process, an output process, a measurement process, and a synchronization control process. The CPU 30 executes the illuminating light control process to operate as the illuminating light control unit 16 illustrated in FIG. 1. The CPU 30 executes the selection process to operate as the selection unit 18 illustrated in FIG. 1. The CPU 30 executes the frame generation process to operate as the frame generation unit 22 illustrated in FIG. 1. The CPU 30 executes the output process to operate as the output unit 24 illustrated in FIG. 1. The CPU 30 executes the measurement process to operate as the measurement unit 20 illustrated in FIG. 1. The CPU 30 executes the synchronization control process to operate as the synchronization control unit 26 illustrated in FIG. 1. Thus, the computer 48 that has executed the image capturing program while the image capturing unit 12 and the radiation unit 14 are connected to the computer 48 functions as the image capturing apparatus 10.

In this embodiment, the image capturing unit 12 captures a moving image at a rate of 30 frames per second (fps). In addition, line-of-sight measurement using a corneal reflection method is performed on every tenth frame. That is, the line-of-sight measurement is performed three times in one second. In addition, the synchronization timer 44 counts up at time intervals corresponding to the frame rate, that is, every 1/30 second. It is to be noted that the frame rate of the image capturing unit 12 and the timing of the line-of-sight measurement are merely examples, and the present disclosure is not limited to these examples.

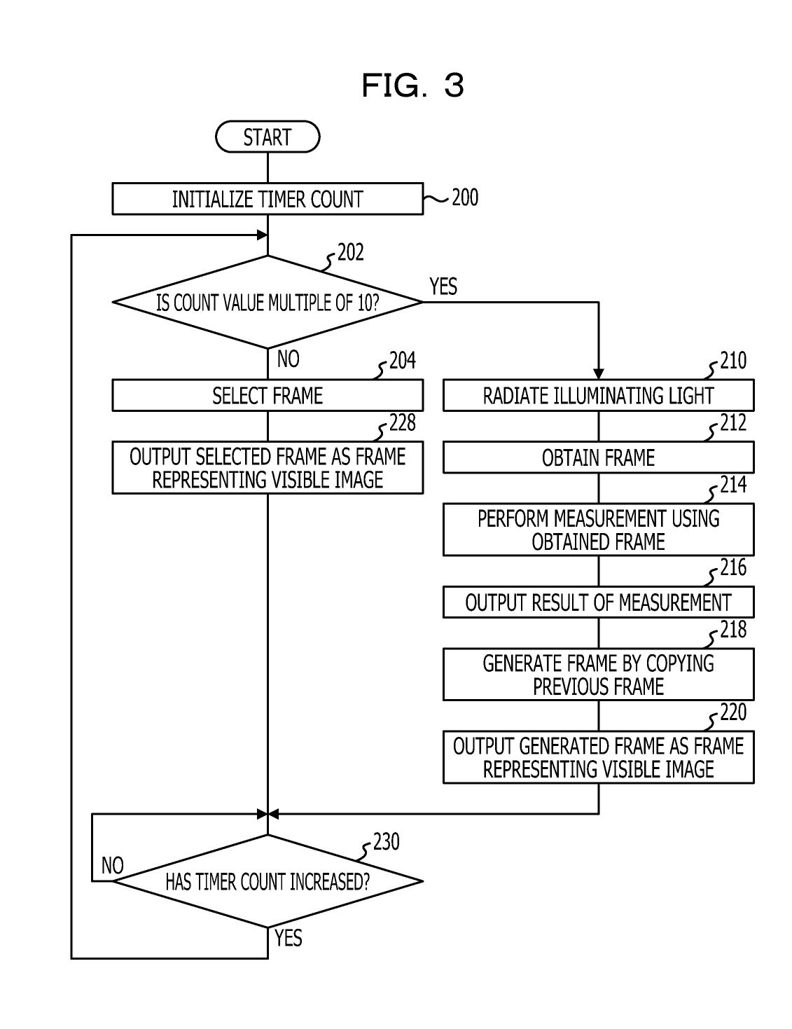

Next, an image capturing process executed by the image capturing apparatus 10 will be described with reference to FIG. 3 as an effect produced by this embodiment. In this embodiment, the radiation unit 14 is off at the beginning of the image capturing process.

In the image capturing process illustrated in FIG. 3, first, the synchronization control unit 26 initializes the synchronization timer 44 to reset the count value to 0 (step 200). Furthermore, the image capturing unit 12 begins to capture a moving image at a certain frame rate.

In step 202, the synchronization control unit 26 judges whether or not the count value of the synchronization timer 44 is a multiple of 10.

If a result of the judgment made in step 202 is negative, the synchronization control unit 26 controls the illuminating light control unit 16, the selection unit 18, and the frame generation unit 22 such that a process when the count value of the synchronization timer 44 is not a multiple of 10 is performed. Therefore, the following process is executed by the corresponding components.

First, the illuminating light control unit 16 controls the radiation unit 14 such that the radiation unit 14 is turned off. During this OFF period, the image capturing unit 12 captures one frame.

In step 204, the selection unit 18 selects image data regarding the captured frame. The selection unit 18 then inputs the selected image data regarding the frame to the frame generation unit 22. In doing so, the frame generation unit 22 stores the image data regarding the frame input from the selection unit 18 in the frame buffer.

In step 228, the frame generation unit 22 inputs the image data input from the selection unit 18 to the output unit 24 as it is. The output unit 24 outputs the image data regarding the frame selected by the selection unit 18 to a certain output target as image data regarding a frame representing a visible image of an image capturing region.

On the other hand, if the result of the judgment made in step 202 is positive, the synchronization control unit 26 controls the illuminating light control unit 16, the selection unit 18, and the frame generation unit 22 such that a process when the count value of the synchronization timer 44 is a multiple of 10 are performed. Therefore, the following process is performed by the corresponding components.

First, the illuminating light control unit 16 controls the radiation unit 14 such that the radiation unit 14 is turned on to radiate infrared light onto the image capturing region of the image capturing unit 12 for a period in which the image capturing unit 12 can capture one frame (step 210). During this ON period of the radiation unit 14, the image capturing unit 12 captures one frame. After turning on the radiation unit 14 for a period in which one frame can be captured, the illuminating light control unit 16 turns off the radiation unit 14.

Thereafter, in step 212, the selection unit 18 obtains image data regarding the frame captured by the image capturing unit 12. The selection unit 18 inputs the obtained image data to the measurement unit 20 as image data to be used for the line-of-sight measurement to cause the measurement unit 20 to execute the line-of-sight measurement.

In step 214, the measurement unit 20 executes the line-of-sight measurement. In step 216, the measurement unit 20 outputs a result of the line-of-sight measurement. A target to which the result of the line-of-sight measurement is output may be a component provided for the image capturing apparatus 10 that executes a certain process using the result of the line-of-sight measurement or may be an external apparatus.

In step 218, the frame generation unit 22 copies image data regarding a last frame captured during an OFF period immediately before a current ON period of the radiation unit 14 and generates a frame representing a visible image of the image capturing region corresponding to the current ON period. In this embodiment, image data regarding a frame held by the frame buffer is read and used. The generated image data regarding the frame is input to the output unit 24. The output unit 24 outputs the input image data as image data regarding the frame representing the visible image corresponding to the current ON period of the radiation unit 14 (step 220).

After step 228 or step 220, the synchronization control unit 26 judges in step 230 whether or not the count value of the synchronization timer 44 has increased by 1. The synchronization control unit 26 waits until the count value of the synchronization timer 44 increases by 1 and, after the increase, returns to step 202 to judge whether or not the count value after the increase is a multiple of 10 and execute the same process as that described above.

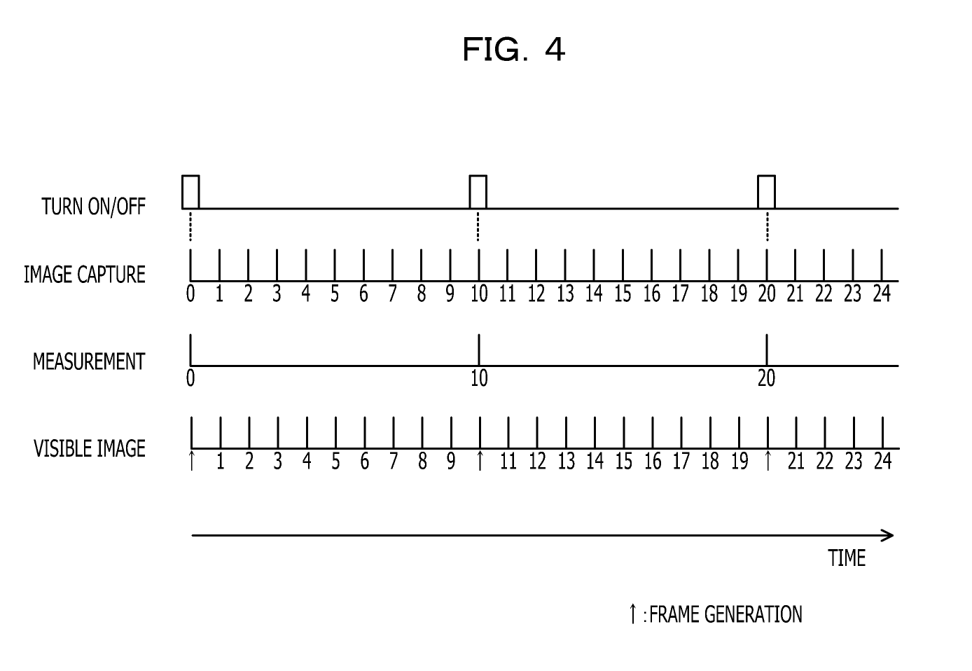

Through the above-described process, in this embodiment, the radiation unit 14 turns on and off, the image capturing unit 12 captures each frame of a moving image, the measurement unit 20 executes measurement, and the output unit 24 outputs image data regarding a frame representing a visible image, as illustrated in a timing chart of FIG. 4.

That is, the radiation unit 14 turns on every ⅓ second (every tenth frame) to execute the line-of-sight measurement. In this embodiment, image data regarding a frame captured during an ON period of the radiation unit 14 is not selected as image data regarding a frame representing a visible image of the image capturing region. Therefore, there is no image data regarding a visible image corresponding to the ON period of the radiation unit 14. For this reason, in this embodiment, the frame generation unit 22 is configured to generate image data regarding a visible image corresponding to a frame at this time. That is, the frame generation unit 22 generates frames of visible images at a timing indicated by arrows illustrated in FIG. 4. For example, a frame of a visible image when the count value of the synchronization timer 44 is 10 is a frame generated by copying a frame of a visible image at a time when the count value is 9.

As described above, in this embodiment, a moving image composed of visible images can be created using only frames captured during OFF periods of the radiation unit 14. Therefore, it is possible to obtain an image whose color has not been deteriorated due to the illuminating light radiated by the radiation unit 14.

The method for generating a frame used by the frame generation unit 22 is not limited to the above example. For example, the frame generation unit 22 may generate a frame representing a visible image of the image capturing region corresponding to an on region of the radiation unit 14 by copying a first frame captured in an OFF period immediately after the ON period of the radiation unit 14.

Alternatively, a frame may be generated by performing frame interpolation using a last frame captured in an OFF period immediately before an ON period of the radiation unit 14 and a first frame captured in an OFF period immediately after the ON period of the radiation unit 14. Here, the frame interpolation refers to an estimation of movement between frames and generation of an interpolation frame to be interpolated between the frames based on a result of the estimation. In this case, the frame generation unit 22 includes at least two frame buffers in order to store image data regarding the two frames before and after the ON period of the radiation unit 14. Every time image data regarding a frame selected by the selection unit 18 is input, the frame generation unit 22 switches the buffer in which the image data is to be stored. In the frame interpolation, image data regarding two frames stored in the frame buffers is used.

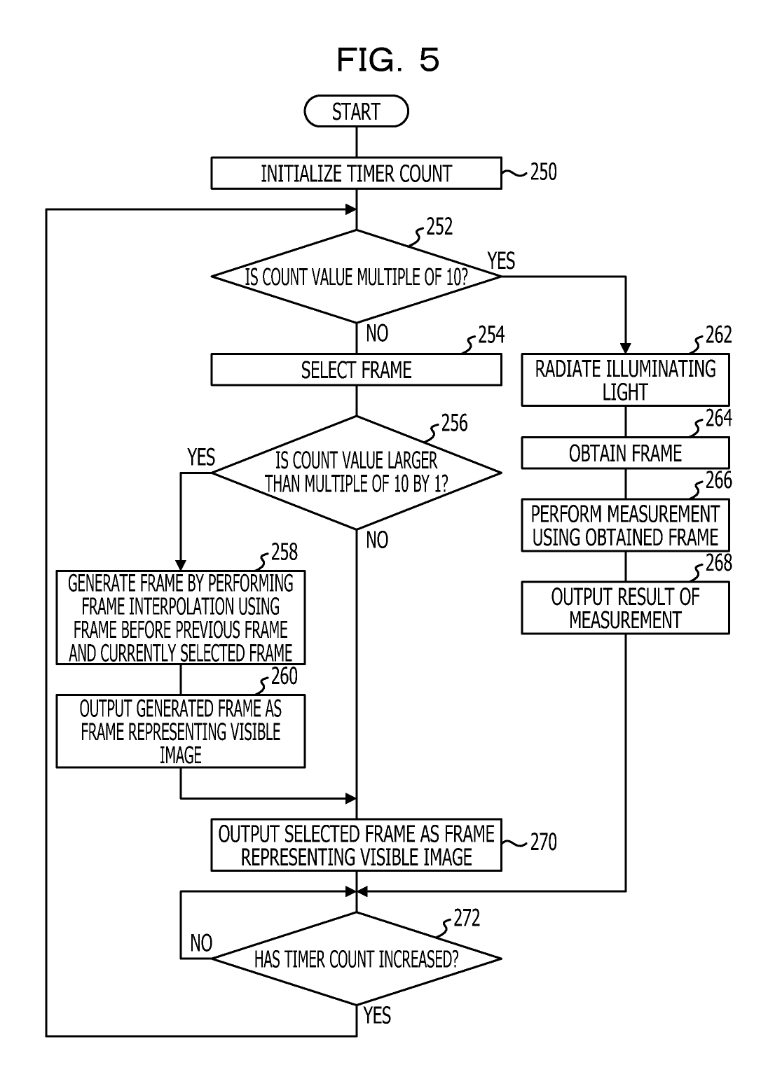

FIG. 5 illustrates the flow of an image capturing process in this case. In the image capturing process illustrated in FIG. 5, first, the synchronization control unit 26 initializes the synchronization timer 44 to reset the count value to 0 (step 250). In step 252, the synchronization control unit 26 judges whether or not the count value of the synchronization timer 44 is a multiple of 10.

If a result of the judgment made in step 252 is positive, the synchronization control unit 26 controls the illuminating light control unit 16 and the selection unit 18 such that a process when the count value of the synchronization timer 44 is a multiple of 10 is performed. Therefore, the following process is performed by the corresponding components.

First, the illuminating light control unit 16 controls the radiation unit 14 such that the radiation unit 14 is turned on to radiate infrared light for a period in which the image capturing unit 12 can capture one frame (step 262). During this ON period of the radiation unit 14, the image capturing unit 12 captures one frame. After turning on the radiation unit 14 for a period in which one frame can be captured, the illuminating light control unit 16 turns off the radiation unit 14.

Thereafter, in step 264, the selection unit 18 obtains image data regarding the frame captured by the image capturing unit 12. The selection unit 18 inputs the obtained image data to the measurement unit 20 as image data to be used for the line-of-sight measurement to cause the measurement unit 20 to execute the line-of-sight measurement. In step 266, the measurement unit 20 executes the line-of-sight measurement. In step 268, the measurement unit 20 outputs a result of the line-of-sight measurement.

On the other hand, if the result of the judgment made in step 252 is negative, the synchronization control unit 26 controls the illuminating light control unit 16, the selection unit 18, and the frame generation unit 22 such that a process when the count value of the synchronization timer 44 is not a multiple of 10 is performed. Therefore, the following process is performed in the corresponding components.

First, the illuminating light control unit 16 controls the radiation unit 14 such that the radiation unit 14 is turned off. During this OFF period of the radiation unit 14, the image capturing unit 12 captures one frame. In step 254, the selection unit 18 selects image data regarding the captured frame. The selection unit 18 then inputs the selected image data regarding the frame to the frame generation unit 22. The frame generation unit 22 stores the image data regarding the frame input from the selection unit 18 in one of the frame buffers.

In step 256, the synchronization control unit 26 judges whether or not the count value of the synchronization timer 44 is larger than a multiple of 10 by 1. If a result of the judgment made in step 256 is positive, the synchronization control unit 26 controls the frame generation unit 22 such that a process when the count value is larger than a multiple of 10 by 1 is performed. Therefore, the following process is performed in the frame generation unit 22.

In step 258, the frame generation unit 22 executes a frame interpolation process using image data stored in the two frame buffers to generate image data regarding a frame of a visible image corresponding to an ON period of the radiation unit 14. That is, the frame generation unit 22 executes the frame interpolation using image data regarding a frame before a previous frame and image data regarding a currently captured frame. The frame generation unit 22 inputs the image data regarding the frame generated by the frame interpolation to the output unit 24. Thus, when a frame is generated by performing the frame interpolation since not only a frame captured immediately before an ON period but also a frame captured immediately after the ON period is used, the output is performed one frame later but it is possible to generate a high quality frame.

A known technique may be used for the frame interpolation executed by the frame generation unit 22. For example, a frame interpolation method disclosed in Japanese Laid-open Patent Publication No. 2009-81561 may be used. More specifically, an interpolation frame between a previous frame and a current frame is generated by obtaining a difference in input time between the current frame and the previous frame and a difference in input time between the previous frame and a frame before the previous frame and by calculating a prediction vector on the basis of a ratio (scale value) of these differences.

In the case of the timing chart of FIG. 4, for example, a frame of a visible image at a time when the count value of the synchronization timer 44 is 10 is generated using a frame of a visible image at a time when the count value is 9 and a frame of a visible image at a time when the count value is 11.

In step 260, the output unit 24 outputs the input image data as image data regarding a frame representing a visible image corresponding to the previous ON period. Thereafter, in step 270, the frame generation unit 22 outputs the image data regarding the current frame selected in step 254 and stored in one of the frame buffers to the output unit 24. The output unit 24 outputs the input image data as image data regarding a frame representing a visible image.

On the other hand, if the result of the judgment made in step 256 is negative, the synchronization control unit 26 controls the frame generation unit 22 such that a process when the count value is not larger than a multiple of 10 by 1 is performed. Therefore, in step 270, the frame generation unit 22 outputs the image data regarding the frame selected in step 254 and stored in one of the two frame buffers to the output unit 24. The output unit 24 outputs the input image data to image data regarding a frame representing a visible image.

After step 268 or step 270, the synchronization control unit 26 judges in step 272 whether or not the count value of the synchronization timer 44 has increased by 1. The synchronization control unit 26 waits until the count value of the synchronization timer 44 increases by 1 and, after the increase, returns to step 252 to judge whether or not the count value after the increase is a multiple of 10 and execute the same process as that described above.

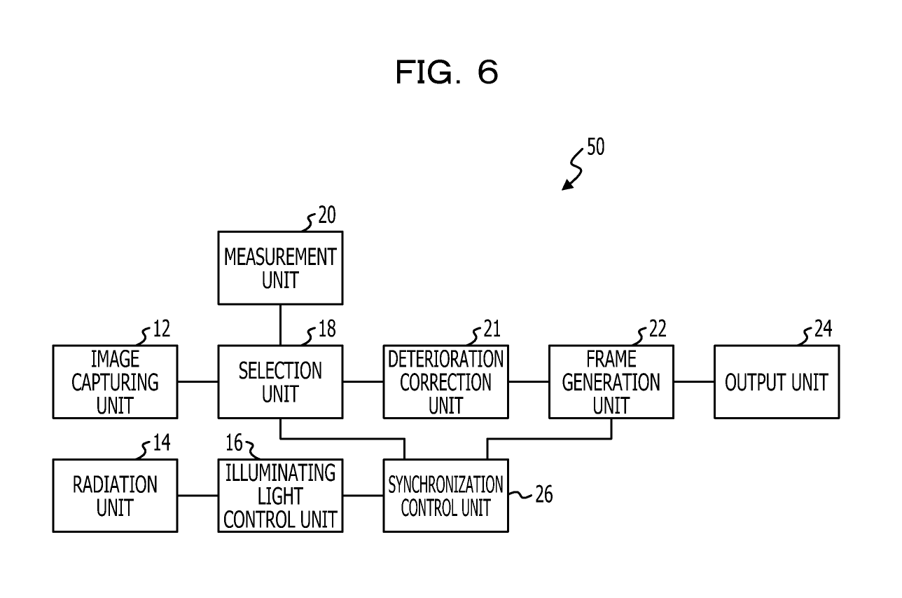

As illustrated in FIG. 6, a deterioration correction unit 21 may be provided between the selection unit 18 and the frame generation unit 22 to configure an input processing unit 50. The deterioration correction unit 21 corrects deterioration of the color of a frame selected by the selection unit 18 due the effect of infrared light. Here, the frame selected by the selection unit 18 is a frame captured during an OFF period of the radiation unit 14, but when natural light or light from an incandescent lamp is radiated onto the image capturing region, the color can be deteriorated due to the effect of light having a wavelength within an infrared range included in the natural light or the light from the incandescent lamp. Therefore, the deterioration correction unit 21 executes a deterioration correction process in which the effect of infrared light upon the color of a visible image is corrected. As the deterioration correction process, a known method may be used. For example, a method disclosed in Japanese Patent No. 4397724 may be used. This method will be briefly described hereinafter.

By exponentiating an RGB signal S1 of a frame to be corrected using a certain first constant as an exponent, an RGB signal S2 is obtained. In addition, by exponentiating the RGB signal S1 of the frame using a certain second constant as an exponent, an RGB signal S3 is obtained. Next, by carrying out a matrix operation in which the RGB signals S1, S2, and S3 are multiplied by a coefficient and results of the multiplication are summed up, an RGB signal whose deterioration has been corrected is obtained.

Here, the constants and the coefficient are determined such that the overall characteristics of a color signal generation unit that generates the RGB signal S1 and the correction process become similar to the chromatic vision characteristics of humans or spectral sensitivity characteristics obtained by executing linear transformation on the chromatic vision characteristics. Furthermore, the constants and the coefficient are determined such that the overall characteristics correct response characteristics in a near-infrared range of the color signal generation unit. In this embodiment, the color signal generation unit is the image capturing unit 12.

When the image capturing apparatus 10 is realized by the computer 48 as described above, the deterioration correction process is included in the image capturing program stored in the storage unit 40. Therefore, the CPU 30 operates as the deterioration correction unit 21 illustrated in FIG. 6 by executing the deterioration correction process.

### Second Embodiment

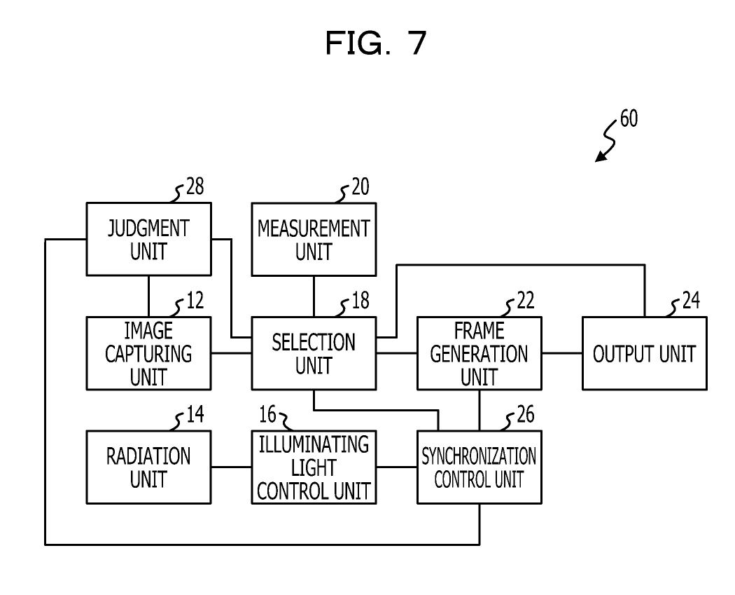

Next, a second embodiment of the present disclosure will be described. As illustrated in FIG. 7, an image capturing apparatus 60 according to the second embodiment has a configuration in which a judgment unit 28 is added to the configuration of the image capturing apparatus 10 according to the first embodiment. Therefore, the same components as those according to the first embodiment are given the same reference numerals and description thereof is omitted. Only differences from the first embodiment will be described.

The judgment unit 28 compares a frame captured during an ON period of the radiation unit 14 and a frame captured during an OFF period of the radiation unit 14 in advance to judge the magnitude of the effect of infrared light upon the color of the frame captured during the period in which the illuminating light of the radiation unit 14 is on. A result of the judgment is input to the selection unit 18 and the synchronization control unit 26.

If the result of the judgment input to the synchronization control unit 26 indicates that the magnitude of the effect is greater than a certain magnitude, the selection unit 18 selects, as in the first embodiment, the frame captured during the OFF period of the radiation unit 14 and outputs the frame to the frame generation unit 22.

If the result of the judgment input to the synchronization control unit 26 indicates that the magnitude of the effect is smaller than or equal to the certain magnitude, the synchronization control unit 26 keeps the radiation unit 14 turned on through the illuminating light control unit 16 while the image capturing unit 12 captures a moving image. The selection unit 18 selects all frames captured during the ON period of the radiation unit 14 while the image capturing unit 12 captures the moving image. In this case, the frames selected by the selection unit 18 are directly input to the output unit 24. In addition, in this case, frames captured at a certain timing among the frames captured during the ON period are input not only to the output unit 24 but also to the measurement unit 20 and used for the measurement process.

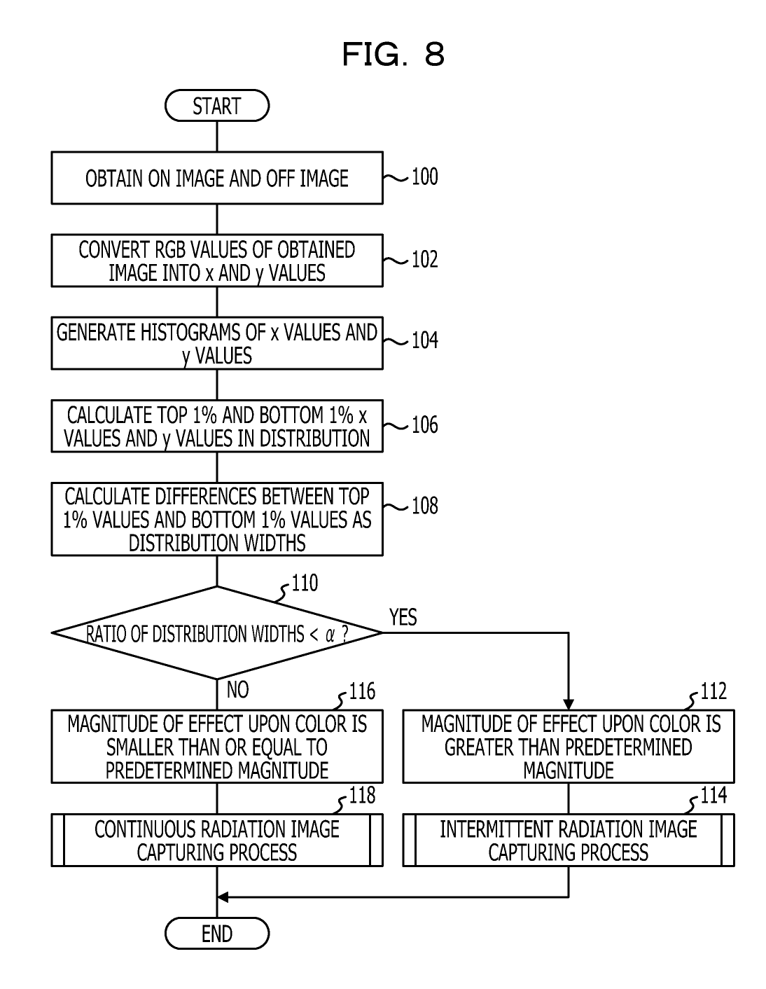

Next, a judgment/image capturing process executed by the image capturing apparatus 60 will be described with reference to FIG. 8 as an effect produced by the second embodiment.

In the judgment/image capturing process illustrated in FIG. 8, in step 100, the image capturing unit 12 captures one frame while the illuminating light control unit 16 controls the radiation unit 14 such that the radiation unit 14 is turned on, and then the image capturing unit 12 captures another frame while the illuminating light control unit 16 controls the radiation unit 14 such that the radiation unit 14 is turned off. The judgment unit 28 obtains image data regarding an on image and image data regarding an off image. The on image is the frame captured during the ON period of the radiation unit 14. The off image is the frame captured during the OFF period of the radiation unit 14. Although an example in which a frame is captured after the radiation unit 14 is turned on and then another frame is captured after the radiation unit 14 is turned off has been described above, a frame may be captured after the radiation unit 14 is turned off and then another frame may be captured after the radiation unit 14 is turned on.

In step 102, the judgment unit 28 converts the RGB values of each pixel in the on image and the off image into x and y values in an XYZ color system using a known conversion expression.

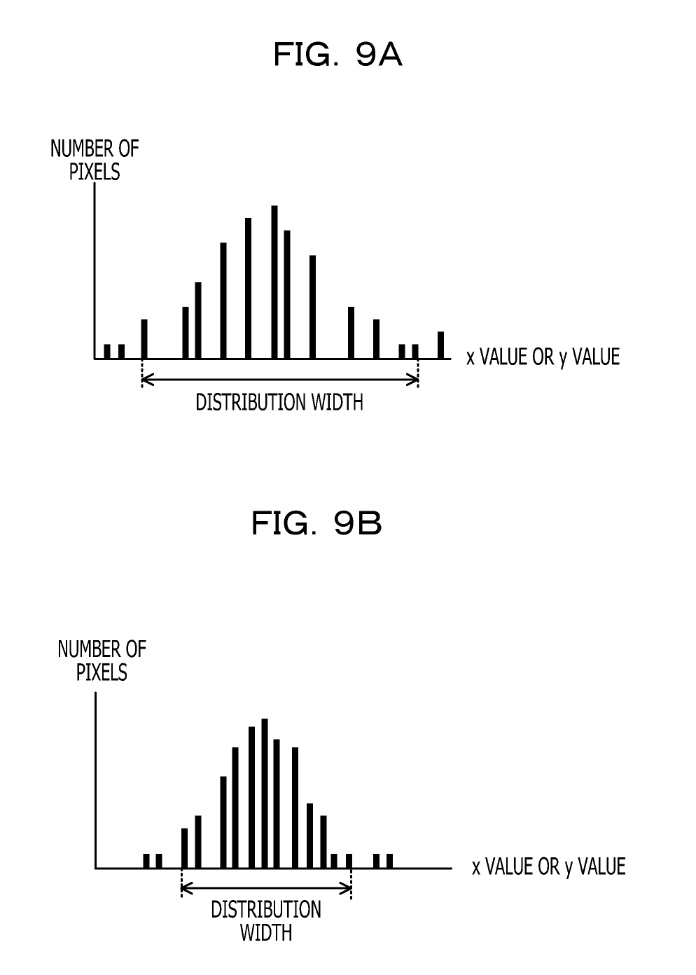

In step 104, as illustrated in FIGS. 9A and 9B, the judgment unit 28 generates histograms of the x values and the y values of the on image and the off image obtained as a result of the conversion.

In step 106, on the basis of the generated histogram of the x values of the on image, the judgment unit 28 calculates x values that occupy the top 1% of all the x values and x values that occupy the bottom 1% of all the x values. In addition, on the basis of the generated histogram of the y values of the on image, the judgment unit 28 calculates y values that occupy the top 1% of all the y values and y values that occupy the bottom 1% of all the y values.

Furthermore, on the basis of the generated histogram of the x values of the off image, the judgment unit 28 calculates x values that occupy the top 1% of all the x values and x values that occupy the bottom 1% of all the x values. In addition, on the basis of the generated histogram of the y values of the off image, the judgment unit 28 calculates y values that occupy the top 1% of all the y values and y values that occupy the bottom 1% of all the y values.

In the following description, the x values that occupy the top 1% will be referred to as the “top 1% x values”, and the y values that occupy the top 1% will be referred to as the “top 1% y values”.

In step 108, in the histogram of the x values of the on image, the judgment unit 28 calculates a difference between the top 1% x values and the bottom 1% x values as a distribution width Ax. In addition, in the histogram of the x values of the off image, the judgment unit 28 calculates a difference between the top 1% x values and the bottom 1% x values as a distribution width Bx. The judgment unit 28 then obtains a ratio Cx of the distribution width Ax to the distribution width Bx. Furthermore, in the histogram of the y values of the on image, the judgment unit 28 calculates a difference between the top 1% y values and the bottom 1% y values as a distribution width Ay. In addition, in the histogram of the y values of the off image, the judgment unit 28 calculates a difference between the top 1% y values and the bottom 1% y values as a distribution width By. The judgment unit 28 then obtains a ratio Cy of the distribution width Ay to the distribution width By. The ratios Cx and Cy are used as values indicating the magnitude of the effect of infrared light upon the color of the frames captured while the illuminating light of the radiation unit 14 is on.

The reason why the difference between the top 1% x values and the bottom 1% x values and the difference between the top 1% y values and the bottom 1% y values are calculated as distribution widths in the histograms of the x values and the y values is that considerably large values and considerably small values are removed and therefore judgments can be made using only significant values. The method for obtaining distribution widths is not limited to this, and, for example, a distribution width may be obtained using a difference between top 2% values and bottom 2% values or a difference between top 3% values and bottom 3% values. Alternatively, all the x values and y values of the pixels may be regarded as significant and a difference between a maximum value and a minimum value may be calculated as a distribution width.

In step 110, the judgment unit 28 judges whether or not the ratio Cx of the distribution widths is smaller than a threshold α and whether or not the ratio Cy of the distribution widths is smaller than the threshold α. If at least either the ratio Cx or the ratio Cy is smaller than the threshold α, the judgment unit 28 judges that a result of the judgment made in step 110 is positive. On the other hand, if both the ratio Cx and the ratio Cy are equal to or larger than the threshold α, the judgment unit 28 judges that the result of the judgment made in step 110 is negative. Here, the threshold α is a value indicating the certain magnitude of the effect.

When the color deteriorates due to the effect of infrared light, the distribution width decreases. That is, when the same image capturing region has been captured, the distribution width of an off image is smaller than that of an on image. In addition, as the difference between the distribution width of an on image and that of an off image becomes larger, the degree of deterioration increases. FIGS. 9A and 9B illustrate specific examples of distribution widths. Since a distribution width illustrated in FIG. 9B is smaller than a distribution width illustrated in FIG. 9A, the magnitude of the effect of infrared light upon the color is greater. Therefore, in this embodiment, the threshold α for evaluating the ratio of distribution widths is certain, and the effect upon the color is judged by comparing the ratios Cx and Cy with the threshold α.

If the result of the judgment made in step 110 is positive, the judgment unit 28 judges in step 112 that the magnitude of the effect of the infrared light radiated from the radiation unit 14 upon the color of a frame captured during an ON period of the radiation unit 14 is greater than the certain magnitude of the effect.

In step 114, the judgment unit 28 inputs the result of the judgment to the selection unit 18 and the synchronization control unit 26, so that an intermittent radiation image capturing process is performed. Thus, the intermittent radiation image capturing process begins. Here, the intermittent radiation image capturing process is, as described in the first embodiment, a process in which the radiation unit 14 is turned on at certain time intervals and frames for the measurement process are captured while a moving image composed of visible images is being captured. Therefore, in step 114, for example, the image capturing process described with reference to FIG. 3 or FIG. 5 is performed.

On the other hand, if the result of the judgment made in step 110 is negative, the judgment unit 28 judges in step 116 that the magnitude of the effect of the infrared light radiated from the radiation unit 14 upon the color of the frame captured during the on frame of the radiation unit 14 is smaller than or equal to the certain magnitude of the effect.

In step 118, the judgment unit 28 inputs the result of the judgment to the selection unit 18 and the synchronization control unit 26, so that a continuous radiation image capturing process is performed. Thus, the continuous radiation image capturing process begins. Here, the continuous radiation image capturing process is a process different from the image capturing process described in the first embodiment in that the radiation unit 14 remains turned on while a moving image is being captured.

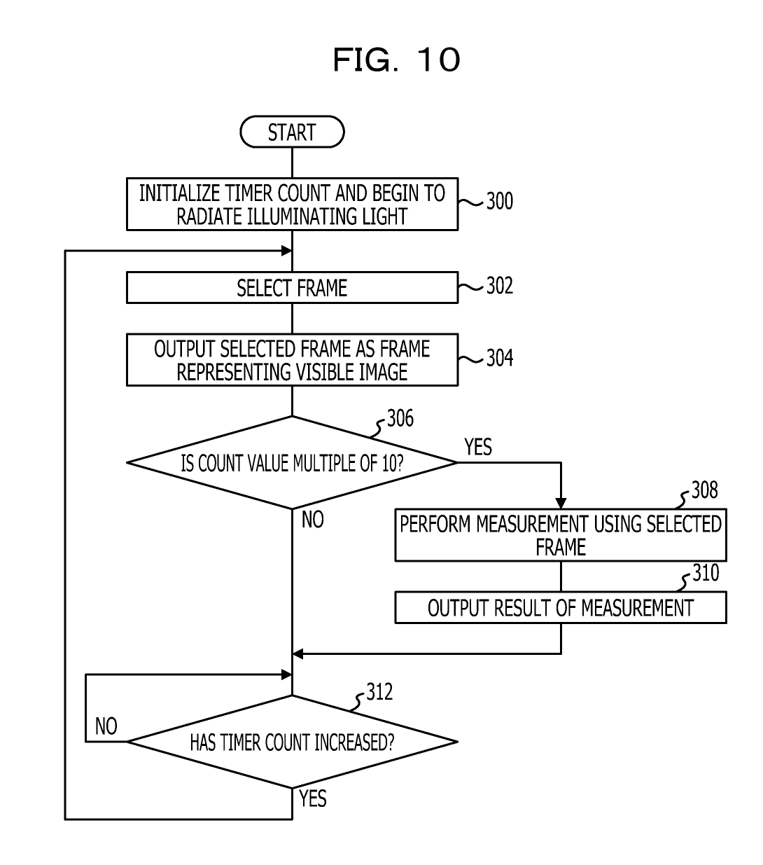

FIG. 10 is a flowchart illustrating an example of the continuous radiation image capturing process.

In the continuous radiation image capturing process illustrated in FIG. 10, first, in step 300, the synchronization control unit 26 initializes the synchronization timer 44 to reset the count value to 0. The synchronization control unit 26 then turns on the radiation unit 14 through the illuminating light control unit 16 to cause the radiation unit 14 to begin to radiate the infrared light. The image capturing unit 12 captures one frame.

In step 302, the selection unit 18 selects image data regarding the captured frame. The selection unit 18 then inputs the selected image data regarding the frame to the output unit 24.

In step 304, the output unit 24 outputs the image data regarding the frame selected by the selection unit 18 to a certain output target as image data regarding a frame representing a visible image of the image capturing region.

In step 306, the synchronization control unit 26 judges whether or not the count value of the synchronization timer 44 is a multiple of 10. If a result of the judgment made in step 306 is positive, the synchronization control unit 26 controls the selection unit 18 such that a process when the count value of the synchronization timer 44 is a multiple of 10 is performed. Therefore, the following process is executed in the corresponding components.

First, in step 308, the selection unit 18 inputs the image data regarding the frame selected in step 302 to the measurement unit 20 as image data to be used for the line-of-sight measurement to cause the measurement unit 20 to execute line-of-sight measurement. Thus, the measurement unit 20 executes the line-of-sight measurement. In step 310, the measurement unit 20 outputs a result of the line-of-sight measurement.

After step 310 or after the synchronization control unit 26 judges in step 306 that the result of the judgment is positive, the synchronization control unit 26 judges in step 312 whether or not the count value of the synchronization timer 44 has increased by 1. The synchronization control unit 26 waits until the count value of the synchronization timer 44 increases by 1 and, after the increase, returns to step 302 to execute the same process as that described above.

Through the above-described process, the radiation unit 14 remains turned on while the image capturing unit 12 captures a moving image. The image capturing region is captured while the radiation unit 14 is on, and captured frames are directly output as frames representing visible images.

Although an example in which the processing in step 304 is performed immediately after step 302 has been described above, the processing in step 304 may be performed after step 306 or step 310.

Thus, in this embodiment, if it is judged that the magnitude of the effect of the illuminating light upon the color is greater than the certain magnitude, the radiation unit 14 is intermittently turned on, and if the magnitude of the effect is smaller than or equal to the certain magnitude, the radiation unit 14 remains turned on. When the radiation unit 14 remains turned on, frames captured during an ON period of the radiation unit 14 are selected and output as frames representing visible images of the image capture region. In this case, the ON period is a period in which the moving image is captured. Therefore, only when the image quality might deteriorate at least to a certain extent, frames are captured while executing control such that the illuminating light of the radiation unit 14 is intermittently turned on. Therefore, the frame generation unit 22 can stop executing processing such as generation of a frame in accordance with necessity, thereby reducing a processing load or the like.

Although an example in which the effect upon the color is judged by comparing the ratios Cx and Cy of the distribution widths with the threshold α has been described above, the judgments may be made by comparing a difference Dx between the distribution width Ax and the distribution width Bx and a difference Dy between the distribution width Ay and the distribution width By with a threshold H. The threshold H, too, is a value indicating the certain magnitude of the effect. In this case, if at least either the difference Dx or the difference Dy is larger than the threshold H, it can be judged that the magnitude of the effect upon the color is greater than the certain magnitude. If both the difference Dx and the difference Dy are smaller than or equal to the threshold H, it can be judged that the magnitude of the effect upon the color is smaller than the certain magnitude.

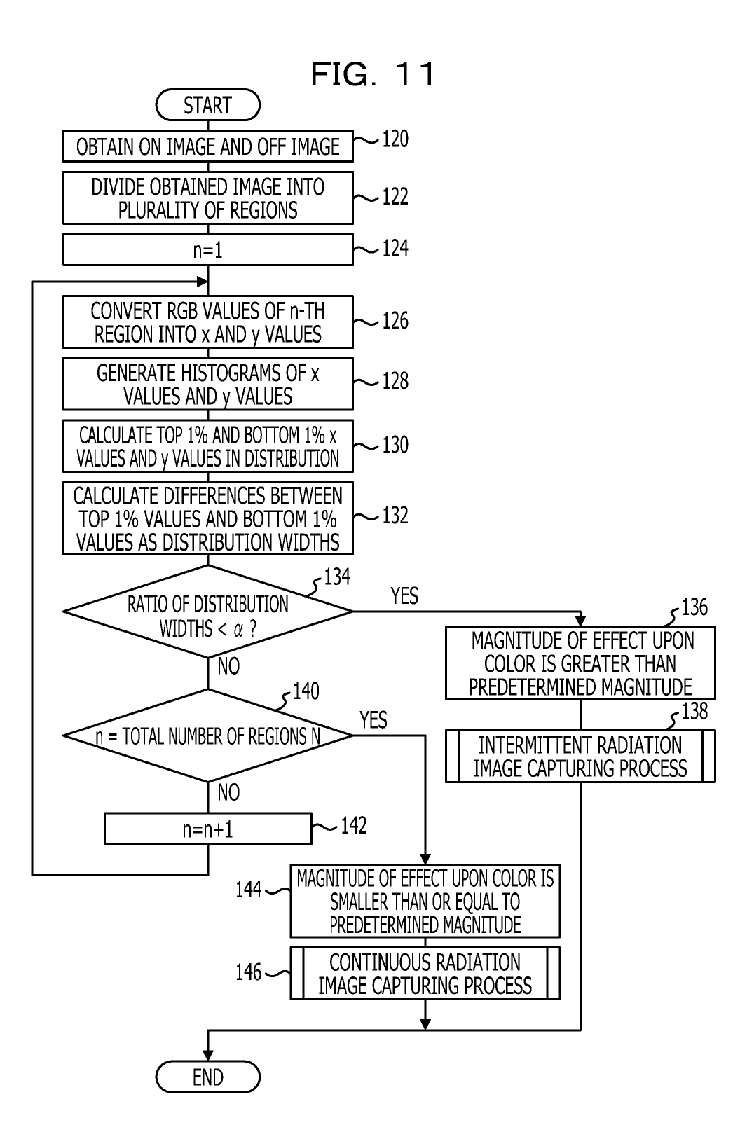

In addition, although an example in which the effect of infrared light upon the color is judged by obtaining the distribution widths of the x values and the y values of the entirety of a frame has been described above, the present disclosure is not limited to this, and a frame may be divided into a plurality of regions and then distribution widths may be obtained to make a judgment. An example in which a frame is divided into a plurality of regions will be described hereinafter with reference to FIG. 11.

In a judgment/image capturing process illustrated in FIG. 11, in step 120, the image capturing unit 12 captures one frame while the illuminating light control unit 16 controls the radiation unit 14 such that the radiation unit 14 is turned on, and the image capturing unit 12 captures one frame while the illuminating light control unit 16 controls the radiation unit 14 such that the radiation unit 14 is turned off. The judgment unit 28 obtains image data regarding an on image and image data regarding an off image. Although an example in which a frame is captured after the radiation unit 14 is turned on and then another frame is captured after the radiation unit 14 is turned off has been described above, a frame may be captured after the radiation unit 14 is turned off and then another frame may be captured after the radiation unit 14 is turned on.

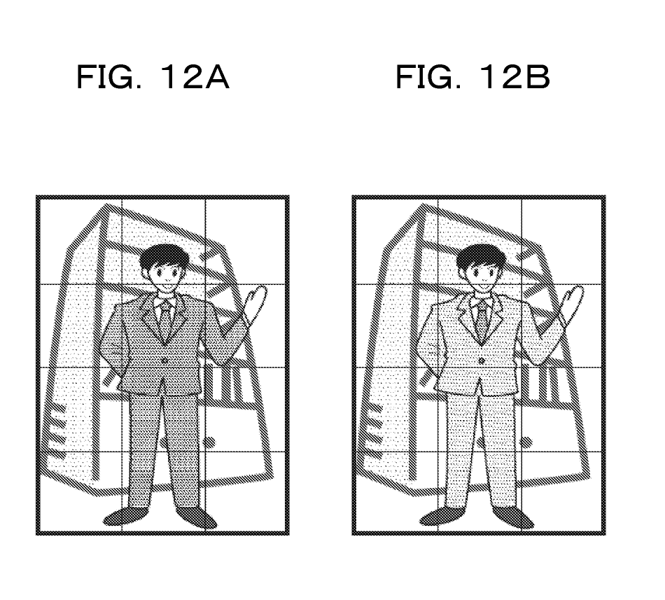

In step 122, the judgment unit 28 divides the obtained on image and off image into a plurality of regions. The same division method is used for the on image and the off image. Examples of the division are illustrated in FIGS. 12A and 12B. FIG. 12A illustrates an example of the off image, and FIG. 12B illustrates an example of the on image. Both images are divided into twelve regions configured by three columns and four rows. The judgment unit 28 provides numbers 1 to N for the regions obtained as a result of the division. N is the total number of regions obtained as a result of the division.

In step 124, the judgment unit 28 sets 1 to a variable n.

In step 126, the judgment unit 28 converts the RGB values of each pixel in an n-th region of the on image and an n-th region of the off image into x and y values in the XYZ color system using a known conversion expression.

In step 128, as illustrated in FIGS. 9A and 9B, the judgment unit 28 generates histograms of the x values and the y values of the n-th region of the on image and the n-th region of the off image obtained as a result of the conversion.

In step 130, on the basis of the histogram of the x values of the n-th region of the on image, the judgment unit 28 calculates the top 1% x values and the bottom 1% x values. In addition, on the basis of the histogram of the y values of the n-th region of the on image, the judgment unit 28 calculates the top 1% y values and the bottom 1% y values. In addition, on the basis of the histogram of the x values of the n-th region of the off image, the judgment unit 28 calculates the top 1% x values and the bottom 1% x values. In addition, on the basis of the histogram of the y values of the n-th region of the off image, the judgment unit 28 calculates the top 1% y values and the bottom 1% y values.

In step 132, in the histogram of the x values of the n-th region of the on image, the judgment unit 28 calculates a difference between the top 1% x values and the bottom 1% x values as the distribution width Ax. In addition, in the histogram of the x values of the n-th region of the off image, the judgment unit 28 calculates a difference between the top 1% x values and the bottom 1% x values as the distribution width Bx. The judgment unit 28 then obtains the ratio Cx of the distribution width Ax to the distribution width Bx. Furthermore, in the histogram of the y values of the n-th region of the on image, the judgment unit 28 calculates a difference between the top 1% y values and the bottom 1% y values as the distribution width Ay. In addition, in the histogram of the y values of the n-th region of the off image, the judgment unit 28 calculates a difference between the top 1% y values and the bottom 1% y values as the distribution width By. The judgment unit 28 then obtains the ratio Cy of the distribution width Ay to the distribution width By.

Although the difference between the top 1% x values and the bottom 1% x values and the difference between the top 1% y values and the bottom 1% y values are calculated as the distribution widths here, this is merely an example and, as described above, the present disclosure is not limited to this.

In step 134, the judgment unit 28 judges whether or not the ratio Cx of the distribution widths is smaller than a threshold α and whether or not the ratio Cy of the distribution widths is smaller than the threshold α. If at least either the ratio Cx or the ratio Cy is smaller than the threshold α, the judgment unit 28 judges that a result of the judgment made in step 134 is positive. On the other hand, if both the ratio Cx and the ratio Cy are equal to or larger than the threshold α, the judgment unit 28 judges that the result of the judgment made in step 134 is negative.

If the result of the judgment made in step 134 is positive, the judgment unit 28 judges in step 136 that the magnitude of the effect of the infrared light radiated from the radiation unit 14 upon the color of the n-th region of a frame captured during an ON period of the radiation unit 14 is greater than the certain magnitude of the effect indicated by the threshold α.

In step 138, the judgment unit 28 inputs the result of the judgment to the selection unit 18 and the synchronization control unit 26, so that the intermittent radiation image capturing process described in the first embodiment is performed. Thus, the intermittent radiation image capturing process begins.

On the other hand, if the result of the judgment made in step 134 is negative, the judgment unit 28 judges in step 140 whether or not the variable n is equal to the total number of regions N. If it is judged in step 140 that the variable n is not equal to the total number of regions N, the judgment unit 28 adds 1 to the variable n in step 142 and returns to step 126 to repeat the same process as that described above for a next region.

On the other hand, if it is judged in step 140 that the variable n is equal to the total number of regions N, the judgment unit 28 judges in step 144 that the magnitude of the effect of the infrared light radiated from the radiation unit 14 is smaller than or equal to the certain magnitude of the effect in all the regions. In step 146, the judgment unit 28 inputs the result of the judgment to the selection unit 18 and the synchronization control unit 26, so that the continuous radiation image capturing process is performed. Thus, as described above, the continuous radiation image capturing process begins.

Thus, by dividing a frame into a plurality of regions and by judging deterioration of color due to infrared light for each region, it is possible to detect deterioration that is difficult to correct, which is effective.

Although an example in which the intermittent radiation image capturing process is performed when it has been judged that the magnitude of the effect of the infrared light upon the color is great in at least one region has been described in this case, the present disclosure is not limited to this. For example, the intermittent radiation image capturing process may be performed when the number of regions in which the magnitude of the effect of infrared light upon the color is great is larger than a certain value.

Although an example in which the effect upon the color is judged by comparing the ratios Cx and Cy of the distribution widths of each region with the threshold α has been described again, the judgment may be made by comparing the difference Dx between the distribution width Ax and the distribution width Bx and the difference Dy between the distribution width Ay and the distribution width By with a threshold h. In this case, if at least either the difference Dx or the difference Dy is larger than the threshold h, it can be judged that the magnitude of the effect upon the color is greater than a certain magnitude indicated by the threshold h. On the other hand, if both the difference Dx and the difference Dy are smaller than or equal to the threshold h, it can be judged that the magnitude of the effect upon the color is smaller than the certain magnitude.

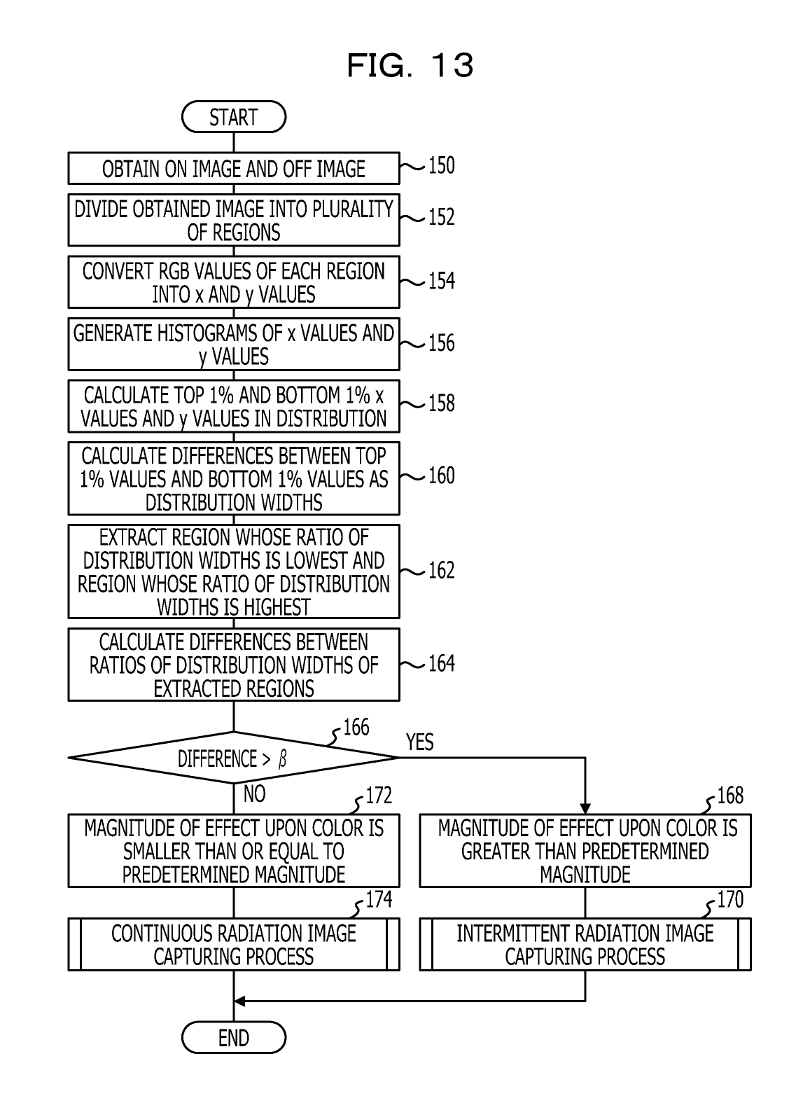

Alternatively, the magnitude of the effect of infrared light may be judged using a method that will be described hereinafter. First, a region M1 whose ratios Cx and Cy of the distribution widths are the lowest and a region M2 whose ratios Cx and Cy of the distribution widths are the largest are extracted from the plurality of regions obtained as a result of the division. Next, differences in the ratios Cx and Cy between the regions M1 and M2 are obtained and a judgment is made by comparing the differences with a threshold. The larger the differences, the magnitude of deterioration of the color is different more significantly between portions of the image capturing region. Even if the deterioration correction process is to be performed, it is difficult to properly correct the entirety of an image in a situation in which the magnitude of deterioration is significantly different between the portions. Therefore, even when the magnitude of deterioration is significantly different between the portions, it is possible, by performing the intermittent radiation image capturing process, to obtain a moving image whose color has not been deteriorated. FIG. 13 is a flowchart illustrating a judgment/image capturing process at a time when an image is captured while the degree of color deterioration is judged on the basis of the differences in the ratios Cx and Cy between the regions M1 and M2.

In the judgment/image capturing process illustrated in FIG. 13, in step 150, the image capturing unit 12 captures one frame while the illuminating light control unit 16 controls the radiation unit 14 such that the radiation unit 14 is turned on, and then the image capturing unit 12 captures one frame while the illuminating light control unit 16 controls the radiation unit 14 such that the radiation unit 14 is turned off. The judgment unit 28 obtains image data regarding an on image and image data regarding an off image. Although an example in which a frame is captured after the radiation unit 14 is turned on and then another frame is captured after the radiation unit 14 is turned off has been described above, a frame may be captured after the radiation unit 14 is turned off and then another frame may be captured after the radiation unit 14 is turned on.

In step 152, the judgment unit 28 divides the obtained on image and off image into a plurality of regions. The same division method is used for the on image and the off image.

In step 154, the judgment unit 28 converts the RGB values of each pixel in each region of the on image and the off image into x and y values in the XYZ color system using a known conversion expression.

In step 156, as illustrated in FIGS. 9A and 9B, the judgment unit 28 generates histograms of the x values and the y values of each region of the on image and the off image obtained as a result of the conversion.

In step 158, as described in step 130 illustrated in FIG. 11, the judgment unit 28 calculates the top 1% x values, the bottom 1% x values, the top 1% y values, and the bottom 1% y values of each region of the on image and the off image.

In step 160, in the histogram of the x values of each region of the on image, the judgment unit 28 calculates a difference between the top 1% x values and the bottom 1% x values as the distribution width Ax. In addition, in the histogram of the x values of each region of the off image, the judgment unit 28 calculates a difference between the top 1% x values and the bottom 1% x values as the distribution width Bx. The judgment unit 28 then obtains the ratio Cx of the distribution width Ax to the distribution width Bx. Furthermore, in the histogram of the y values of each region of the on image, the judgment unit 28 calculates a difference between the top 1% y values and the bottom 1% y values as the distribution width Ay. In addition, in the histogram of the y values of each region of the off image, the judgment unit 28 calculates a difference between the top 1% y values and the bottom 1% y values as the distribution width By. The judgment unit 28 then obtains the ratio Cy of the distribution width Ay to the distribution width By.

Although the difference between the top 1% x values and the bottom 1% x values and the difference between the top 1% y values and the bottom 1% y values are calculated as the distribution widths here, this is merely an example and, as described above, the present disclosure is not limited to this.

In step 162, the judgment unit 28 extracts the region M1 whose ratios Cx and Cy are the lowest and the region M2 whose ratios Cx and Cy are the highest. If the ratios Cx and Cy are the lowest or the highest in different regions, a region in which a value obtained by summing the ratios Cx and Cy is the lowest and a region in which a value obtained summing the ratios Cx and Cy is the highest may be extracted.

In step 164, the judgment unit 28 calculates differences between the ratios of the distribution widths of the extracted regions M1 and M2. That is, the judgment unit 28 calculates a difference SBx between the ratios Cx of the region M1 and the ratio Cx of the region M2 and a difference SBy between the ratio Cy of the region M1 and the ratio Cy of the region M2.

In step 166, the judgment unit 28 judges whether or not the difference SBx exceeds a certain threshold β and whether or not the difference SBy exceeds the threshold β. If at least either the difference SBx or the difference SBy exceeds the threshold β, the judgment unit 28 judges that a result of the judgment made in step 166 is positive. If both the difference SBx and the difference SBy are smaller than the threshold β, the judgment unit 28 judges that the result of the judgment made in step 166 is negative. Here, the threshold β is a value indicating the certain magnitude of the effect.

If the result of the judgment made is step 166 is positive, the judgment unit 28 then judges in step 168 that the magnitude of the effect of the infrared light radiated from the radiation unit 14 upon the color of a frame captured during an ON period of the radiation unit 14 is greater than the certain magnitude of the effect.

In step 170, the synchronization control unit 26 inputs the result of the judgment to the selection unit 18 and the synchronization control unit 26, so that the intermittent radiation image capturing process described in the first embodiment is performed. Thus, the intermittent radiation image capturing process begins.

On the other hand, if the result of the judgment made in step 166 is negative, the judgment unit 28 judges in step 172 that the magnitude of the effect of the infrared light radiated from the radiation unit 14 upon the color of the frame captured during the ON period of the radiation unit 14 is smaller than or equal to the certain magnitude of the effect. In step 174, the judgment unit 28 inputs the result of the judgment to the selection unit 18 and the synchronization control unit 26, so that the continuous radiation image capturing process is performed. Thus, as described above, the continuous radiation image capturing process begins.

Although an example in which the judgment unit 28 calculates the difference SBx in the ratio Cx and the difference SBy in the ratio Cy between the regions M1 and M2 and judges the effect upon the color by comparing these values with the threshold β has been described above, the present disclosure is not limited to this, and, for example, the judgment may be made in the following manner. For example, first, the judgment unit 28 extracts a region m1 in which the difference Dx between the distribution width Ax and the distribution width Bx and the difference Dy between the distribution width Ay and the distribution width By are the smallest and a region m2 in which the difference Dx between the distribution width Ax and the distribution width Bx and the difference Dy between the distribution width Ay and the distribution width By are the largest. The judgment unit 28 then calculates a difference SDx between the difference Dx of the region m1 and the difference Dx of the region m2 and a difference SDy between the difference Dy of the region m1 and the difference Dy of the region m2. The judgment unit 28 then judges whether or not the difference SDx exceeds a certain threshold γ and whether or not the difference SDy exceeds the threshold γ. If at least either the difference SDx or the difference SDy exceeds the threshold γ, the judgment unit 28 judges that the magnitude of the effect of the infrared light radiated from the radiation unit 14 is greater than a certain magnitude of the effect indicated by the threshold γ. On the other hand, if both the difference SDx and the difference SDy are smaller than the threshold γ, the judgment unit 28 judges that the magnitude of the effect of the infrared light radiated from the radiation unit 14 is smaller than or equal to the certain magnitude of the effect indicated by the threshold γ.

Although an example in which the continuous radiation image capturing process is performed when it has been judged that the magnitude of the effect of infrared light upon the color is smaller than or equal to the certain magnitude has been described in this embodiment, the present disclosure is not limited to this. For example, as described in the first embodiment, even if it is judged that the magnitude of the effect is small, the radiation unit 14 may be intermittently turned on and the selection unit 18 may select not only a frame captured during an OFF period of the radiation unit 14 but also a frame captured during an ON period of the radiation unit 14. In this case, the frames selected by the selection unit 18 are directly input to the output unit 24 without passing through the frame generation unit 22. In addition, the frame captured during the ON period is input not only to the output unit 24 but also to the measurement unit 20 and used for the measurement process.

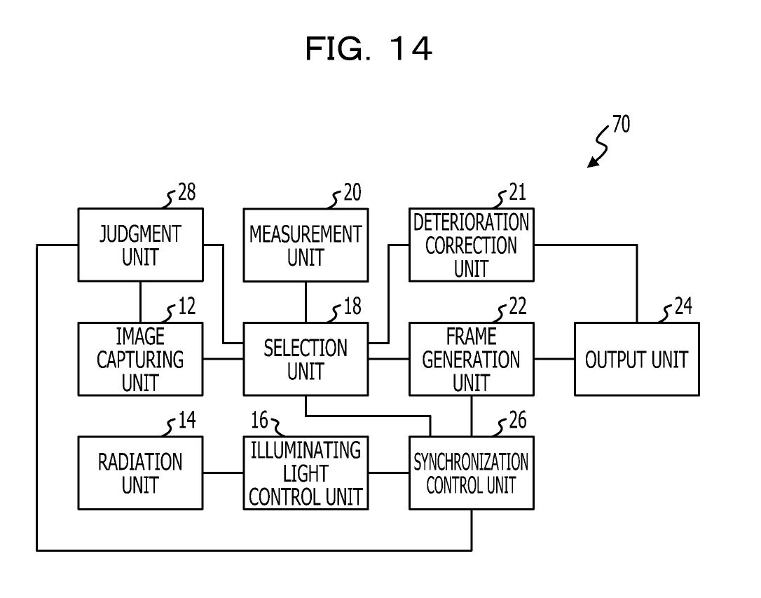

In addition, in this embodiment, as illustrated in FIG. 14, the deterioration correction unit 21 may be provided between the selection unit 18 and the output unit 24 to configure an image capturing apparatus 70. In this case, the deterioration correction unit 21 corrects deterioration of the color of a frame selected by the selection unit 18 in the continuous radiation image capturing process due to the effect of infrared light.

### Third Embodiment

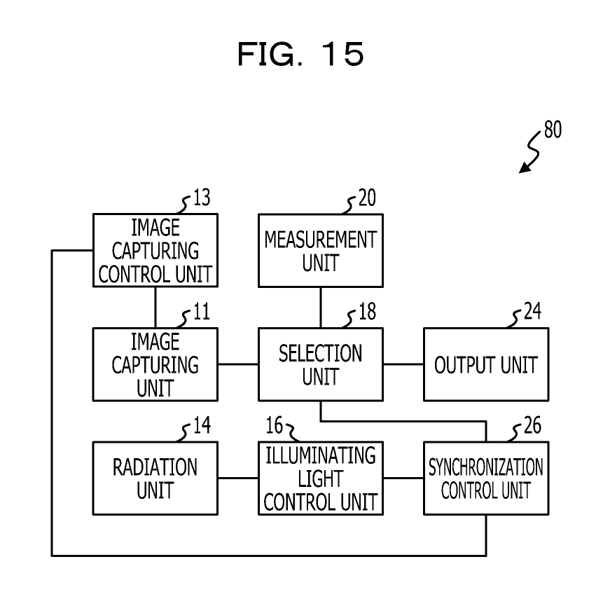

Next, a third embodiment of the present disclosure will be described. As illustrated in FIG. 15, an image capturing apparatus 80 according to the third embodiment does not include the frame generation unit 22, which is included in the configuration of the image capturing apparatus 10 described in the first embodiment, but is configured to include an image capturing control unit 13. In addition, unlike the image capturing unit 12 according to the first embodiment, an image capturing unit 11 according to this embodiment is configured to be able to capture an image in a period shorter than an image capturing frame rate at which frames representing visible images of the image capturing region are captured. In this embodiment, the image capturing frame rate is 30 fps, and the image capturing unit 11 is configured to be able to capture an image at a rate of 60 fps.

The image capturing control unit 13 changes the frame rate of the image capturing unit 11 in accordance with control executed by the synchronization control unit 26. The image capturing control unit 13 controls the image capturing unit 11 such that, for example, the image capturing unit 11 captures a moving image at a rate of 60 fps, which is a period shorter than the image capturing frame rate, namely 30 fps, at least for a certain period in a period in which the image capturing unit 11 captures the moving image.

The selection unit 18 selects image data regarding a frame captured during an OFF period of the radiation unit 14 and inputs the image data to the output unit 24. The output unit 24 outputs the input image data regarding the frame to an output target as image data regarding a frame representing a visible image of the image capturing region.

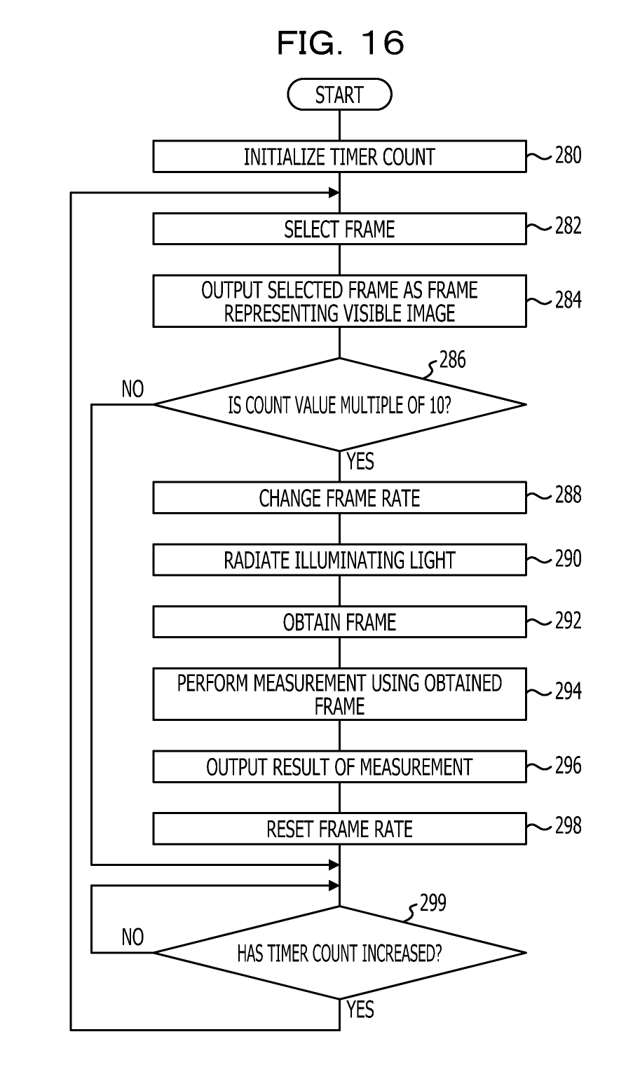

Next, an image capturing process executed by the image capturing apparatus 80 will be described with reference to FIG. 16 as an effect produced by this embodiment. In this embodiment, the radiation unit 14 is off at the beginning of the image capturing process.

In the image capturing process illustrated in FIG. 16, first, the synchronization control unit 26 initializes the synchronization timer 44 to reset the count value to 0 (step 280). At this time, the radiation unit 14 is off, and the image capturing unit 12 captures one frame in this state.

In step 282, the selection unit 18 selects image data regarding a frame captured during an OFF period of the radiation unit 14. The selection unit 18 then inputs the selected image data regarding the frame to the output unit 24.

In step 284, the output unit 24 outputs the image data regarding the frame selected by the selection unit 18 to a certain output target as image data regarding a frame representing a visible image of the image capturing region.

In step 286, the synchronization control unit 26 judges whether or not the count value of the synchronization timer 44 is a multiple of 10.

If a result of the judgment made in step 286 is positive, the synchronization control unit 26 controls the image capturing control unit 13, the illuminating light control unit 16, and the selection unit 18 such that a process when the count value of the synchronization timer 44 is a multiple of 10 is performed. Therefore, the following process is performed in the corresponding components.

First, in step 288, the image capturing control unit 13 changes the frame rate of the image capturing unit 11 from 30 fps to 60 fps. In doing so, for example, when the current count value of the synchronization timer 44 is 10, one frame is captured before the count value of the synchronization timer 44 becomes 11.

In step 290, the illuminating light control unit 16 controls the radiation unit 14 such that the radiation unit 14 is turned on to radiate the infrared light for a period in which the image capturing unit 11 can capture one frame. During this ON period of the radiation unit 14, the image capturing unit 11 captures one frame. After turning on the radiation unit 14 for the period in which one frame can be captured, the illuminating light control unit 16 turns off the radiation unit 14.

Thereafter, in step 292, the selection unit 18 obtains image data regarding the frame captured by the image capturing unit 11. The selection unit 18 inputs the obtained image data to the measurement unit 20 as image data used for the line-of-sight measurement to cause the measurement unit 20 to execute the line-of-sight measurement.

In step 294, the measurement unit 20 executes the line-of-sight measurement. In step 296, the measurement unit 20 outputs a result of the line-of-sight measurement.

In step 298, the image capturing control unit 13 resets the frame rate from 60 fps to 30 fps. The process for resetting the frame rate may be performed at any time before the count value of the synchronization timer 44 increases by 1 after the image capturing unit 11 captures one frame at a frame rate of 60 fps.

On the other hand, if the synchronization control unit 26 judges in step 286 that the result of the judgment is negative, the processing in step 288 to step 298 is not performed.

In step 299, the synchronization control unit 26 judges whether or not the count value of the synchronization timer 44 has increased by 1. The synchronization control unit 26 waits until the count value of the synchronization timer 44 increases by 1 and, after the increase, returns to step 282 to judge whether or not the count value after the increase is a multiple of 10 and execute the same process as that described above.

That is, in the above example, the radiation unit 14 is turned on for a period in which one frame can be captured and an additional frame is captured and obtained as a frame for the measurement process before the count value of the synchronization timer 44 increases by 1 after the count value becomes a multiple of 10. The additional frame is not selected as a frame representing a visible image. A frame selected by the selection unit 18 as a frame representing a visible image is a frame captured at a normal image capture frame rate (30 fps). Because each frame captured at the normal image capturing frame rate (30 fps) is a frame captured during an OFF period and is not used for the measurement process, no frame is absent and therefore the frame generation unit 22 does not generate a frame.

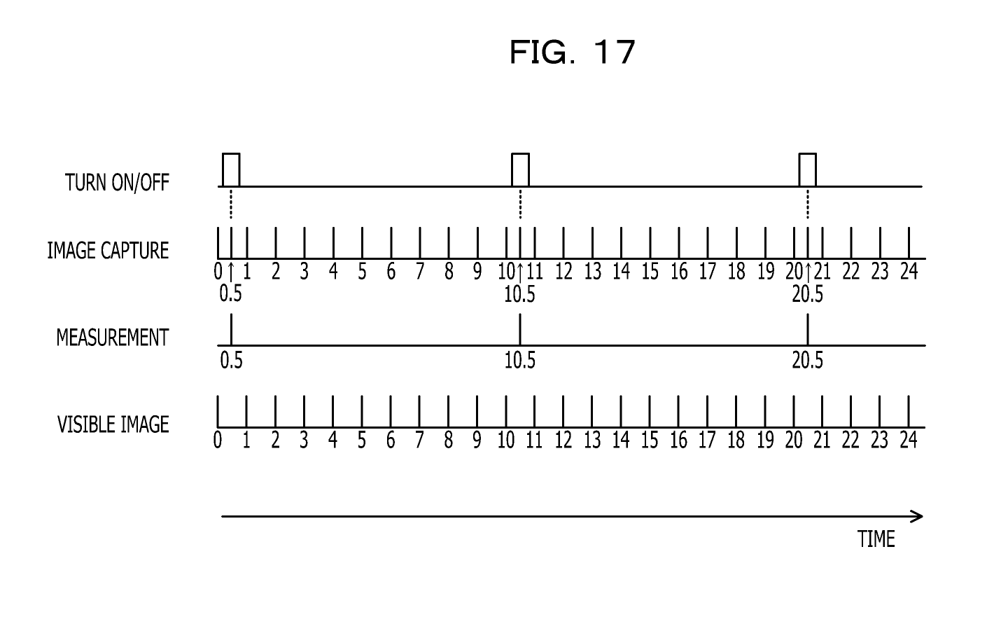

Through the above-described process, in this embodiment, the radiation unit 14 turns on and off, the image capturing unit 12 captures each frame of a moving image, the measurement unit 20 executes measurement, and the output unit 24 outputs image data regarding a frame representing a visible image, as illustrated in a timing chart of FIG. 17. In FIG. 17, the timing at which additional frames are captured is indicated by adding fractions of 0.5 to the multiples of 10.

Although an example in which the frame rate is switched to capture an additional frame has been described in this embodiment, the present disclosure is not limited to this. For example, the image capturing unit 11 may be configured to capture frames at a frame rate at least twice as high as the certain image capturing frame rate, which is a frame rate at which the image capturing unit 11 captures a moving image composed of visible images, and a desired frame may be selected from the captured frames and used.

More specifically, for example, while the image capturing unit 11 captures a moving image, the image capturing control unit 13 drives the image capturing unit 11 such that the image capturing unit 11 continuously captures frames at a rate of 60 fps, and the selection unit 18 is configured to select every other frame from the captured frames and output the frames as frames representing visible images. In doing so, a visible moving image whose frame rate is 30 fps can be obtained. In this case, the illuminating light control unit 16 controls the radiation unit 14 such that the radiation unit 14 is turned on at the timing at which frames other than the frames selected by the selection unit 18 are captured, and the selection unit 18 obtains the frames captured during this ON period and inputs the frames to the measurement unit 20.

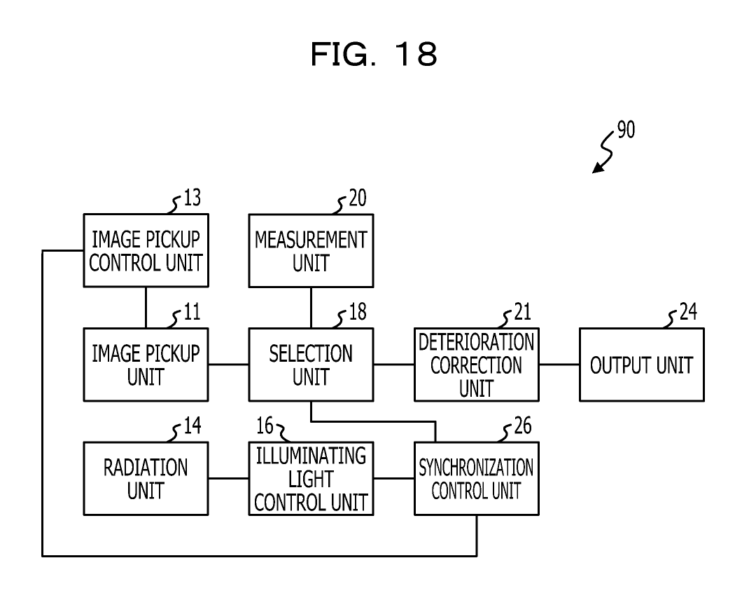

In addition, in this embodiment, too, as illustrated in FIG. 18, the deterioration correction unit 21 may be provided between the selection unit 18 and the output unit 24 to configure an image capturing apparatus 90, and deterioration of the color of a frame selected by the selection unit 18 due to the effect of the infrared light may be corrected. This is because, as in the first embodiment, the color can be deteriorated due to the effect of light having a wavelength within the infrared range included in natural light or light from an incandescent lamp when the natural light or the light from the incandescent lamp is radiated onto the image capturing region.

Although various embodiments have been described above, the present disclosure is not limited to these embodiments. For example, although the measurement process executed by the measurement unit 20 has been described as the line-of-sight measurement, this may be distance measurement in which a distance (three-dimensional coordinates) from an object present in the image capturing region to the image capturing unit 12 is measured, instead. A known method may be used to measure the distance. For example, a coded pattern light projection method may be used. In this method, infrared light having a specially coded pattern is projected onto the image capturing region and three-dimensional coordinates are measured on the basis of a relationship between a direction in which the pattern light is projected and a measurement direction determined by the position of a pixel in a captured image. When this method is to be used, the radiation unit 14 is supposed to be configured to be able to radiate infrared light having a certain pattern.

In addition, although an example in which the illuminating light radiated from the radiation unit 14 is infrared light has been described in the above embodiments, the present disclosure is not limited to these embodiments. For example, light (red laser light or the like) in a certain wavelength range in a visible range may be used, instead. In this case, the image capturing unit 12 may be configured to include a filter that blocks infrared light.

In addition, an embodiment is possible in which both the second embodiment and the third embodiment are applied. That is, as described above, if the judgment unit 28 judges that the magnitude of the effect upon the color is smaller than or equal to the certain magnitude, the continuous radiation image capturing process is performed. On the other hand, as described in the third embodiment, if the judgment unit 28 judges that the magnitude of the effect upon the color is greater than the certain magnitude, the image capturing control unit 13 switches the frame rate of the image capturing unit 11 at certain time intervals and additional frames are captured.

Furthermore, although an aspect in which the image capturing program is stored in the storage unit 40 has been described above, the image capturing program may be recorded on a portable computer-readable recording medium such as a compact disc read-only memory (CD-ROM), a digital versatile disc read-only memory (DVD-ROM), or a universal serial bus (USB) memory and provided.

All the documents, patent applications, and technology standards described herein are incorporated herein by reference to the same extent as when it is specifically and individually described that the individual documents, patent applications, and technology standards are incorporated herein by reference.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image capturing apparatus comprising:
an image capturing device in which a plurality of pixels having sensitivity to visible light and illuminating light in a certain wavelength range are arranged and that captures a moving image having a plurality of frames;
a radiation device that radiates the illuminating light onto an image capturing region of the image capturing device; and
a processor that executes a procedure, the procedure comprising:
selecting, from among a plurality of frames captured by the image capturing device, a frame captured during an OFF period of the radiation device, and
outputting the selected frame as a frame representing a visible image of the image capturing region.

2. The image capturing apparatus according to claim 1, the procedure further comprising:
executing a measurement process using another frame captured during an ON period of the radiation device.

3. The image capturing apparatus according to claim 1, wherein the radiation device radiates the illuminating light mainly composed of infrared light.

4. The image capturing apparatus according to claim 3, the procedure further comprising:
correcting color deterioration of the selected frame due to an effect of infrared light radiated from a light source different from the radiation device, and
wherein the outputting outputs the corrected frame.

5. The image capturing apparatus according to claim 1, the procedure further comprising:
generating, on the basis of the frame captured during the OFF period of the radiation device, another frame representing a visible image in an ON period of the radiation device, and
outputting the other frame as a visible image in the ON period.

6. The image capturing apparatus according to claim 5, wherein the generating of the other frame generates the other frame by copying a last frame captured during an OFF period immediately before the ON period or a first frame captured during an OFF period immediately after the ON period.

7. The image capturing apparatus according to claim 5, wherein the generating of the other frame generates the other frame on the basis of a frame interpolation process performed on a last frame captured during an OFF period immediately before the ON period and a first frame captured during an OFF period immediately after the ON period.

8. The image capturing apparatus according to claim 1, the procedure further comprising:
executing control in which intervals at which the image capture device captures the moving image are switched between first intervals and second intervals, which are shorter than the first intervals,
executing, in a period in which the image capturing device captures the moving image at the first intervals, control such that the radiation device is turned off,
executing, in a period in which the image capturing device captures the moving image at the second intervals, control such that the radiation device is turned on, and
outputting the frame captured during the OFF period of the radiation device as the frame representing the visible image.

9. The image capturing apparatus according to claim 1, the procedure further comprising:
comparing a first frame captured during an ON period of the radiation device and a second frame captured during an OFF period of the radiation device, and
calculating, on the basis of a result of the comparison, a value indicating a magnitude of an effect of the illuminating light upon color of the first frame, and
wherein the selecting selects a frame captured during an ON period of the radiation device from among the plurality of frames and the frame captured during the OFF period, when the value is smaller than or equal to a threshold.

10. The image capturing apparatus according to claim 9, wherein the comparing divides the first frame into a plurality of regions, divides the second frame into a plurality of regions, and compares each of the plurality of regions of the first frame with each of the plurality of regions of the second frame.

11. The image capturing apparatus according to claim 9, the procedure further comprising:
instructing, when the value is larger than the threshold, the radiation device to turn on at a timing for a certain ON period and to turn off in periods other than the ON period.

12. The image capturing apparatus according to claim 9, the procedure further comprising:
executing, when the value is smaller than or equal to the threshold, control such that the radiation device remains turned on while the image capturing device captures the moving image.

13. An image capturing method executed by a computer, the image capturing method comprising:
sequentially obtaining a plurality of frames from an image capturing device in which a plurality of pixels having sensitivity to visible light and illuminating light in a certain wavelength range are arranged and that captures a moving image having a plurality of frames;
controlling a radiation device that radiates the illuminating light onto an image capturing region of the image capturing device;
selecting, from among a plurality of frames captured by the image capturing device, a frame captured during an OFF period of the radiation device; and
outputting the selected frame as a frame representing a visible image of the image capturing region.

14. The image capturing method according to claim 13, further comprising:
executing a measurement process using another frame captured during an ON period of the radiation device.

15. The image capturing method according to claim 13, further comprising:
correcting color deterioration of the selected frame due to an effect of infrared light radiated from a light source different from the radiation device, and
wherein the outputting outputs the corrected frame.

16. The image capturing method according to claim 13, further comprising:
generating, on the basis of the frame captured during the OFF period of the radiation device, another frame representing a visible image in an ON period of the radiation device; and
outputting the other frame as a visible image in the ON period.

17. A computer-readable recording medium storing an image capturing program for causing a computer to execute a process, the process comprising:
sequentially obtaining a plurality of frames from an image capturing device in which a plurality of pixels having sensitivity to visible light and illuminating light in a certain wavelength range are arranged and that captures a moving image having a plurality of frames;
controlling a radiation device that radiates the illuminating light onto an image capturing region of the image capturing device;
selecting, from among a plurality of frames captured by the image capturing device, a frame captured during an OFF period of the radiation device; and
outputting the selected frame as a frame representing a visible image of the image capturing region.

18. The computer-readable recording medium according to claim 17, the process further comprising:
executing a measurement process using another frame captured during an ON period of the radiation device.

19. The computer-readable recording medium according to claim 17, the process further comprising:
correcting color deterioration of the selected frame due to an effect of infrared light radiated from a light source different from the radiation device, and
wherein the outputting outputs the corrected frame.

20. The computer-readable recording medium according to claim 17, the process further comprising:
generating, on the basis of the frame captured during the OFF period of the radiation device, another frame representing a visible image in an ON period of the radiation device; and
outputting the other frame as a visible image in the ON period.
